(19) United States
(12) Patent Application Publication
(10) Pub. No.: US 2005/0200585 A1
(43) Pub. Date: Sep. 15, 2005

(54) Display device array substrate and display device

(76) Inventors: Kazuaki Igarashi, Ishikawa-Gun (JP); Kentaro Teranishi, Kanazawa-Shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/044,204

(22) Filed: Jan. 28, 2005

Related U.S. Application Data
(63) Continuation of application No. PCT/JP04/06278, filed on Apr. 30, 2004.

(30) Foreign Application Priority Data
Apr. 30, 2003 (JP) 2003-125613

(51) Int. Cl. G09G 3/36

(52) U.S. Cl. 345/93

(57) ABSTRACT

An array substrate includes m pixel columns in each of which n pixels PX are arranged in an effective display portion DSP_{eff}, and dummy pixel columns obtained by arranging dummy pixels outside the effective display portion DSP_{eff}. Each pixel and each dummy pixel include a switching element placed at the intersection of each scanning line and each signal line. One switching element is connected per row to each signal line. A switching element in the Nth row of the Mth pixel column and a switching element in the (N+1)th row of the (M+1)th pixel column are connected to the same signal line, and video signals having opposite polarities are supplied to adjacent signal lines.

### CROSS REFERENCE TO RELATED APPLICATIONS

This is a Continuation Application of PCT Application No. PCT/JP2004/006278, filed Apr. 30, 2004, which was published under PCT Article 21(2) in Japanese.

This application is based upon and claims the benefit of priority from prior Japanese Patent Application No. 2003-125613, filed Apr. 30, 2003, the entire contents of which are incorporated herein by reference.

### BACKGROUND OF THE INVENTION

1. Field of the Invention

The present invention relates to a display device array substrate and display device, and more particularly, to the structure of an array substrate which forms a display device such as a liquid crystal display device.

2. Description of the Related Art

Recently, many flat display devices, represented by liquid crystal display devices, use an active matrix driving system having thin-film transistors each of which functions as a switching element in each of the pixels arranged in a matrix. In display devices like this, the line resistance and line capacitance of lines for transferring signals such as video signals are increasing in accordance with the demands for large screens. This leads to insufficient charging of each pixel, and degrades the display quality. Therefore, it is essential to improve the capability of a signal line driving circuit for driving signal lines (i.e., for supplying predetermined video signals to signal lines).

If the capability of the signal line driving circuit is improved, however, IC chips included in the signal line driving circuit generate heat as the electric power increases. Also, improving the capability of the signal line driving circuit complicates the circuit structure, and this increases the cost. Therefore, Jpn. Pat. Appln. KOKAI Publication No. 10-171412, for example, proposes a liquid crystal display device using a dot inversion driving system in which the structure of a signal line driving circuit is simplified. This reference discloses a technique which drives two rows of pixels with one signal line.

In this structure, however, two types of video signal different in polarity must be sequentially supplied to each signal line during one horizontal scanning period. It is also necessary to supply video signals having opposite polarities to each signal line in each horizontal scanning period. This increases the number of times of switching, and increases the load on the signal line driving circuit.

### BRIEF SUMMARY OF THE INVENTION

The present invention has been made in consideration of the above situation, and has as its object to provide a display device array substrate and display device capable of preventing deterioration of the display quality, and reducing the load on a driving circuit without increasing the cost.

A display device array substrate according to the first aspect of the present invention is characterized by comprising a plurality of scanning lines running in a row direction on a substrate; a plurality of signal lines running in a column direction on the substrate; and an effective display portion having m pixel columns in each of which n rows of pixels are arranged, wherein the display device array substrate comprises dummy pixel columns obtained by arranging dummy pixels on outsides of the effective display portion, which are adjacent to first and mth pixel columns of the effective display portion, each pixel and each dummy pixel include a switching element placed at an intersection of each scanning line and each signal line, and one switching element is connected per row to each signal line, a switching element in an Nth row of an Mth pixel column and a switching element in an (N+1)th row of an (M+1)th pixel column are connected to the same signal line, and video signals having opposite polarities are supplied to adjacent signal lines.

A display device according to the second aspect of the present invention is characterized by comprising an array substrate including a plurality of scanning lines running in a row direction on a substrate, a plurality of signal lines running in a column direction on the substrate, and a switching element placed at an intersection of each scanning line and each signal line; a counter-substrate which opposes the array substrate; and a liquid crystal layer held between the array substrate and counter-substrate, wherein the display device comprises an effective display portion having m pixel columns in each of which n pixels are arranged, and dummy pixel columns obtained by arranging dummy pixels on outsides of the effective display portion, which are adjacent to first and mth pixel columns of the effective display portion, each pixel and each dummy pixel including the switching element, the display device further comprises: a scanning line driving circuit which is connected to each scanning line, and outputs a driving signal for driving switching elements connected to the same scanning line; a controller which rearranges video data in a predetermined order in accordance with an arrangement of the pixels; and a signal line driving circuit which is connected to each signal line, and outputs a video signal to each signal line on the basis of the video data rearranged by the controller, and one switching element is connected per row to each signal line, a switching element in an Nth row of an Mth pixel column and a switching element in an (N+1)th row of an (M+1)th pixel column are connected to the same signal line, and video signals having opposite polarities are supplied to adjacent signal lines.

### BRIEF DESCRIPTION OF THE SEVERAL VIEWS OF THE DRAWING

FIG. 1 is a view schematically showing the arrangement of a liquid crystal display device including a display device array substrate according to an embodiment of the present invention;

FIG. 2 is a view showing an example of the arrangement of pixels in a display region of the display device array substrate shown in FIG. 1;

FIG. 3 is a conceptual view for explaining the first embodiment, and is a view for explaining the relationships between output channels and switching elements of pixels connected to signal lines;

FIG. 4 is a conceptual view for explaining the first embodiment, and is a view for explaining the relationship between video data and a display image displayed on an effective display portion;

FIG. 5 is a conceptual view for explaining the second embodiment, and is a view for explaining the relationships between output channels and switching elements of pixels connected to signal lines;

FIG. 6 is a conceptual view for explaining the second embodiment, and is a view for explaining the relationship between video data and a display image displayed on an effective display portion; and

FIG. 7 is a view showing another example of the arrangement of the pixels in the display region of the display device array substrate shown in FIG. 1.

### DETAILED DESCRIPTION OF THE INVENTION

A display device array substrate and display device according to an embodiment of the present invention will be described below with reference to the accompanying drawing. Although the display device array substrate herein mentioned is extensively applicable as an array substrate which forms a flat display device, a liquid crystal display device will be explained as an example of the flat display device.

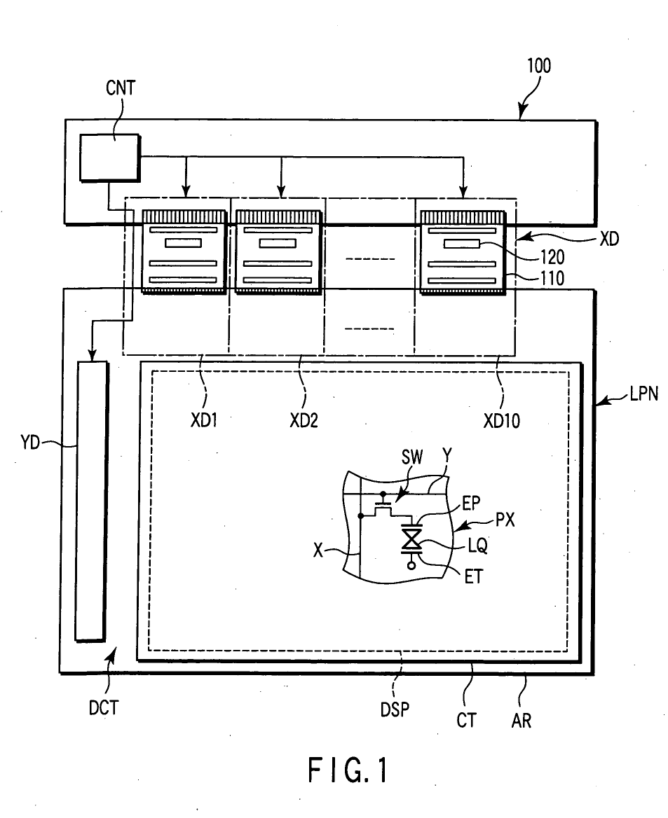

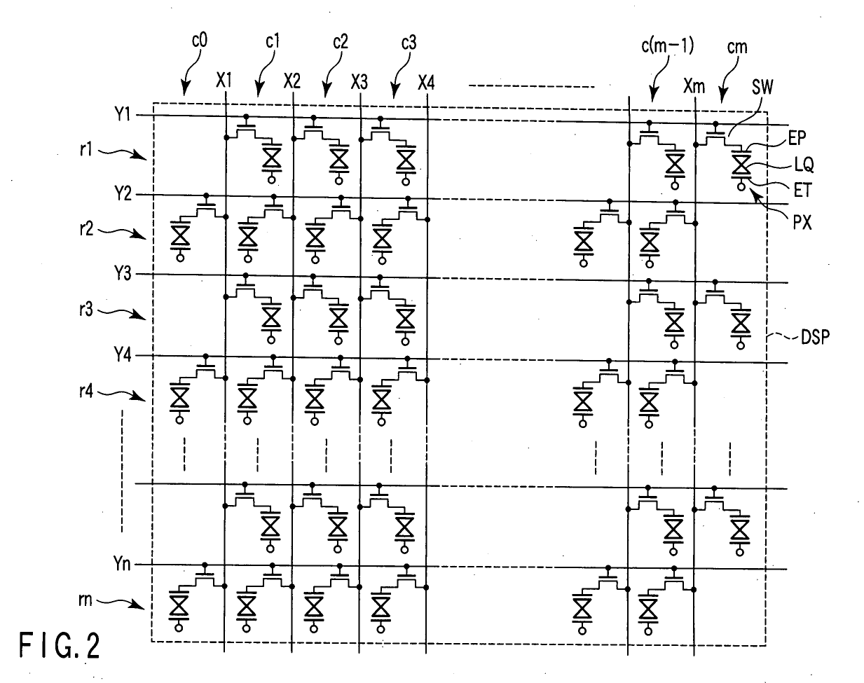

As shown in FIGS. 1 and 2, the liquid crystal display device is an active matrix driving type color liquid crystal display device, and includes a liquid crystal display panel LPN, driving printed circuit board (PCB) 100, and the like. The liquid crystal display panel LPN and driving printed circuit board 100 are connected via tape carrier package (TCP) 110. Each TCP 110 is obtained by mounting a signal line driving IC 120 on a flexible printed circuit board. The TCPs 110 are electrically connected to the liquid crystal display panel LPN via, e.g., an anisotropic conductive film (ACF), and connected to the driving printed circuit board 100 by soldering or the like. Although the signal line driving ICs 120 are connected as the TCPs 110 in this embodiment, the signal line driving ICs 120 may also be connected to the liquid crystal display panel LPN by chip-on-glass (COG). It is also possible to integrate the signal line driving ICs 120 with switching elements of pixels in the liquid crystal display panel LPN in the same process.

The liquid crystal display panel LPN includes an array substrate AR, a counter-substrate CT which opposes the array substrate AR, and a liquid crystal layer LQ held between the array substrate AR and counter-substrate CT. The liquid crystal display panel LPN includes a plurality of pixels PX substantially arranged in an m×n matrix in a display region DSP having a diagonal length of 32 inches (approximately 81.28 cm).

The array substrate AR has, in the display region DSP, n scanning lines Y (Y1 to Yn) formed along rows on the substrate, m signal lines X (X1 to Xm) formed along columns on the substrate, m×n switching elements (e.g., thin-film transistors) SW arranged near the intersections of the corresponding scanning lines Y and corresponding signal lines X at individual pixels, m×n pixel electrodes EP connected to the switching elements SW, and the like.

On the other hand, the counter-substrate CT has a single counter-electrode ET and the like in the display region DSP. The counter-electrode ET opposes the pixel electrodes EP of all the pixels PX.

In a peripheral region DCT of the display region DSP, the array substrate AR integrally has a scanning line driving circuit YD connected to the n scanning lines Y. The driving printed circuit board 100 includes a controller CNT, power supply circuit (not shown), and the like. The controller CNT rearranges video data in a predetermined order in accordance with the pixel arrangement (to be described later) unique to this embodiment, and outputs the rearranged video data, a polarity signal, various control signals, and the like.

The scanning line driving circuit YD is formed in the same process as the switching elements of the pixels, generates a driving signal for driving the switching elements SW connected to the same scanning line Y, and sequentially outputs driving signals to the n scanning lines Y under the control of the controller CNT.

The signal line driving ICs 120 generate video signals corresponding to the video data rearranged in the predetermined order by the controller CNT, and, under the control of the controller CNT, sequentially output the video signals to the m signal lines X at the timing at which the switching elements SW of the individual rows are turned on by driving signals. Consequently, the pixel electrode EP of each pixel PX is set at a pixel potential corresponding to the video signal supplied via the corresponding switching element SW.

The signal line driving ICs 120 are each allocated to a predetermined number of signal lines, thereby forming sections XD1, XD2, . . . , XD10. In this embodiment, 10 signal line driving ICs 120 control the corresponding sections.

In the liquid crystal display panel LPN having the above arrangement, the surface of the array substrate AR and the surface of the counter-substrate CT are covered with orientation films. Also, the array substrate AR and counter-substrate CT are adhered with the surfaces having the orientation films opposing each other. The array substrate AR and counter-substrate CT are adhered via a spacer, and a predetermined gap is formed between them. The liquid crystal layer LQ is made of a liquid crystal composition containing liquid crystal molecules sealed in the gap formed between the orientation film of the array substrate AR and the orientation film of the counter-substrate CT.

Note that the liquid crystal display panel LPN described above can be constructed as either a reflection type display panel which displays images by selectively reflecting ambient light, or a transmission type display panel which displays images by selectively transmitting light from a backlight. To realize this selective reflection or transmission, the liquid crystal display panel LPN includes a deflecting plate or phase difference plate on the outer surface of at least one of the array substrate AR and counter-substrate CT. Also, to make color display possible, the liquid crystal display panel LPN has stripe-shaped color filters of three primary colors, e.g., red, green, and blue, on at least one of the array substrate AR and counter-substrate CT.

In this embodiment, the array substrate AR includes the pixels PX laid out as shown in FIG. 2 in the display region DSP. That is, the m switching elements SW are connected to the same scanning line Y to form a row r. In this embodiment, n rows r (r1 to rn) are formed in one-to-one correspondence with the n scanning lines Y (Y1 to Yn).

Also, the n switching elements SW are connected to the same signal line X to form a pixel column c. In this embodiment, one switching element is connected per row to each signal line X, and n/2 switching elements SW forming each of two pixel columns are connected to each signal line X. In this manner, the n switching elements are connected by the same pattern to all the signal lines X regardless of whether these switching elements contribute to display, so the capacitances of the individual signal lines can be made equal to each other, and the occurrence of display defects can be prevented.

In the layout shown in FIG. 2, the switching elements SW forming a first pixel column c1 in odd-numbered rows, such as the first, third, fifth, . . . , rows, are connected to the signal line X1 in the first column, and the switching elements SW forming a second pixel column c2 in even-numbered rows, such as the second, fourth, sixth, . . . , nth rows, are connected to the signal line X1 in the first column. That is, the switching elements SW connected to the same signal line are alternately arranged in two pixel columns in every other row.

In this arrangement, the n/2 switching elements SW forming the first pixel column c1 are connected to the signal line X1, and the n/2 switching elements SW forming the second pixel column c2 are similarly connected to the signal line X1.

That is, a switching element SW in an Nth row rN of an (M+1)th pixel column c(M+1) and a switching element SW in an (N+1)th row r(N+1) of an Mth pixel column cM are connected to the same signal line X(M+1) (e.g., M=0, N=1). Note that in the embodiment shown in FIG. 2, M is an integer of 0 or more, and N is an integer of 1 or more.

Also, one pixel column placed between two adjacent signal lines, e.g., a pixel column cM placed between a signal line XM in the Mth column and a signal line X(M+1) in the (M+1)th column are made up of the switching element SW connected to the signal line XM in the Nth row rN, and the switching element SW connected to the signal line X(M+1) in the (N+1)th row r(N+1) (e.g., M=1, N=1).

In a structure in which one pixel column is placed between two adjacent signal lines, one pixel column is desirably formed by connecting all switching elements in odd-numbered rows forming the pixel column to one of adjacent signal lines (i.e., a signal line placed along one side of the pixel column), and all switching elements in even-numbered rows forming the pixel column to the other of the adjacent signal lines (i.e., a signal line placed along the other side of the pixel column).

In the layout shown in FIG. 2, the pixel column c2, for example, placed between the signal line X1 in the first column and the signal line X2 in the second column is made up of the n/2 switching elements SW connected to the signal line (one signal line) X2 in odd-numbered rows such as the first, third, fifth, . . . , rows, and the n/2 switching elements SW connected to the signal line (the other signal line) X1 in even-numbered rows such as the second, fourth, sixth, . . . , nth rows.

In the display region DSP as described above, each of the pixel columns (c1 to c(m−1)) from the first column to the (m−1)th column is made up of n pixels PX, and each of the 0th pixel column c0 and mth pixel column cm is made up of n/2 pixels PX.

In the display region DSP having the above pixel arrangement, dot inversion driving in which pixels adjacent to each other in the row and column directions are given different polarities can be performed by supplying video signals having opposite polarities to adjacent signal lines. In this case, the signal line driving ICs 120 output video signals having the same polarity to the individual signal lines for one frame, i.e., for n horizontal scanning periods (one vertical scanning period) during which n scanning lines are driven.

In the Fth frame (e.g., an odd-numbered frame), for example, the signal line driving ICs 120 output video signals positive with reference to a reference signal to signal lines in odd-numbered columns, such as the signal lines X1, X3, . . . , and output video signals negative with reference to the reference signal to signal lines in even-numbered columns, such as the signal lines X2, X4, . . . .

Also, in the (F+1)th frame (e.g., an even-numbered frame) following the Fth frame, the signal line driving ICs 120 output video signals negative with reference to a reference signal to signal lines in odd-numbered columns, such as the signal lines X1, X3, . . . , and output video signals positive with reference to the reference signal to signal lines in even-numbered columns, such as the signal lines X2, X4, . . . . This makes both dot inversion driving and frame inversion driving possible in the display region DSP.

As described above, with respect to the same signal line, the signal line driving IC 120 outputs a video signal having the same polarity in, e.g., the same frame (one vertical scanning period), and inverts the polarity of the video signal in each frame. By this dot inversion driving system, the number of times of switching for inverting the polarity of the video signal can be reduced (the number of times of switching can be reduced from, e.g., each horizontal scanning period to each vertical scanning period). Therefore, the load on the signal line driving circuit can be reduced. This makes it possible to eliminate insufficient charging of each pixel, and prevent deterioration of the display quality. It is also possible to simplify the arrangement of the signal line driving circuit, and decrease the cost.

For the display region DSP having the pixel arrangement as described above, video data must be compensated for by taking account of the relationship between the pixel arrangement and lines. Two embodiments will be described in detail below.

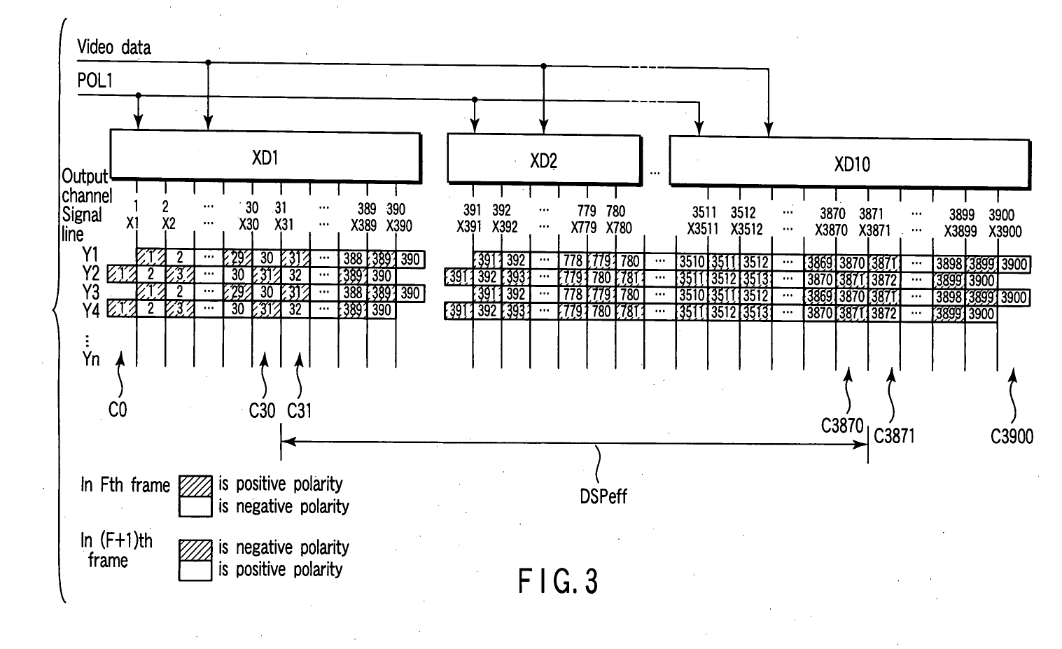

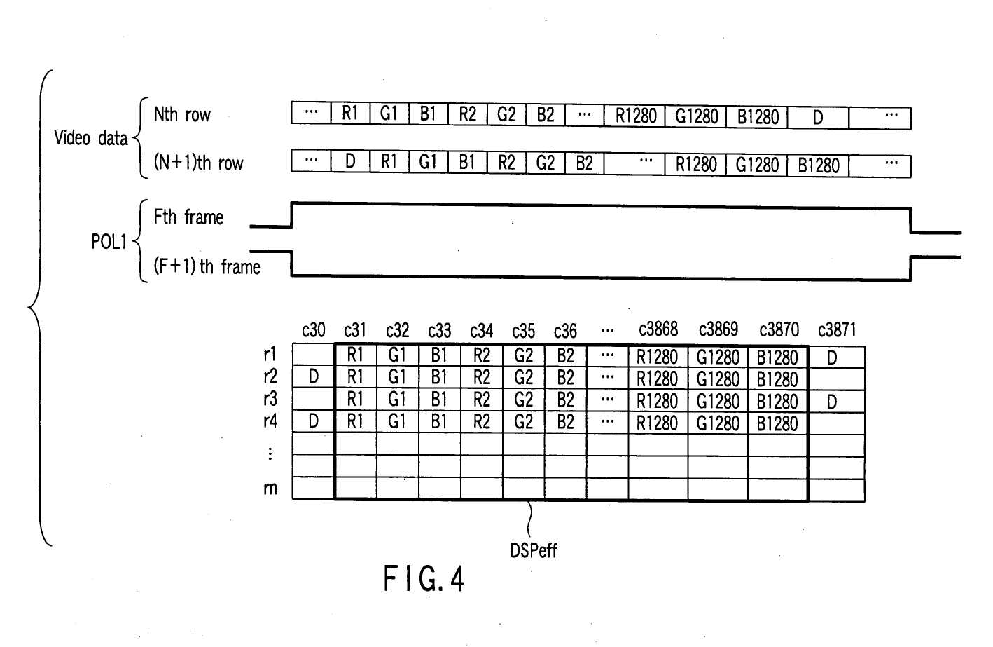

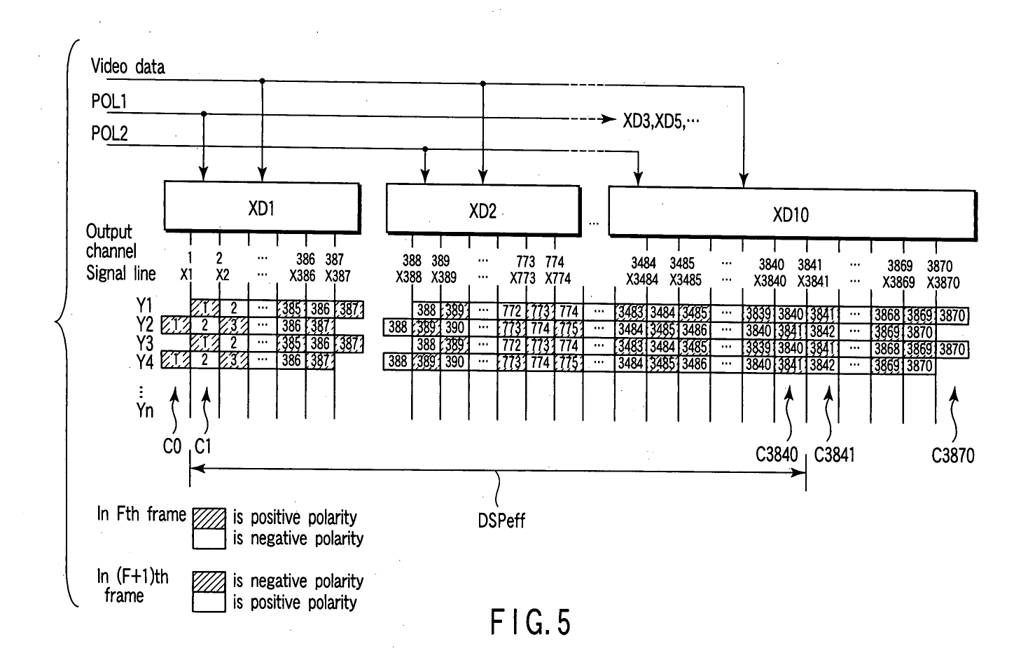

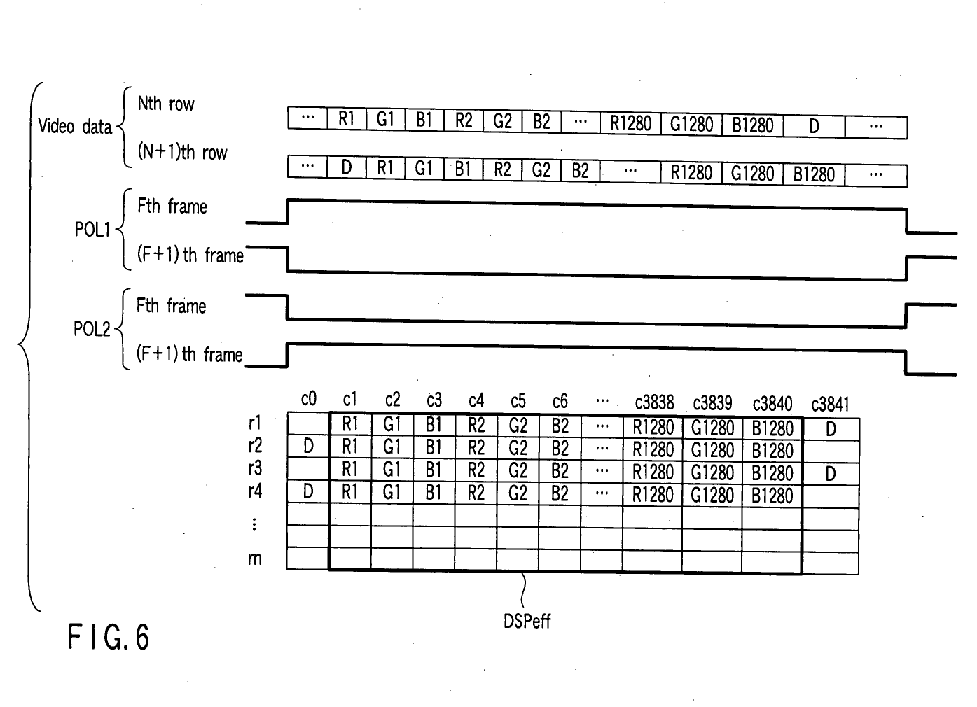

Note that in each embodiment, 1,280 red color filters, 1,280 green color filters, and 1,280 blue color filters are arranged in the form of stripes parallel to the pixel columns in the order of R (red), G (green), B (blue), R, G. . . . Note also that in FIGS. 3 and 5, the number of each pixel (e.g., “1”) indicates a switching element connected to a signal line (e.g., “X1”) having the same number. Furthermore, note that in FIGS. 4 and 6, R1, R2, . . . , R1280 correspond to video signals for red pixels, G1, G2, . . . , G1280 correspond to video signals for green pixels, and B1, B2, . . . , B1280 correspond to video signals for blue pixels.

### First Embodiment

In the first embodiment as shown in FIG. 3, signal line driving ICs 120 have 3,900 output channels for outputting video signals to 3,900 signal lines X1 to X3900, and include 10 sections XD1 to XD10 each allocated to 390 signal lines.

Also, the display region DSP has a rectangular effective display portion DSP_{eff} which substantially displays images. That is, the effective display portion DSP_{eff} is defined to have m pixel columns in each of which n pixels are arranged. On those outsides of the effective display portion, which are adjacent to the first and mth pixel columns in the effective display portion DSP_{eff}, dummy pixels which do not contribute to image display are arranged to form dummy pixel columns.

In the example shown in FIG. 3, 3,840 pixel columns from a 31st first pixel column c31 to a 3,870th pixel column c3870 form the effective display portion DSP_{eff}. Also, 31 pixel columns from a 0th pixel column c0 adjacent to a pixel column c31 to a 30th pixel column c30 are dummy pixel columns. Similarly, 30 pixel columns from a 3,871st pixel column c3871 adjacent to the pixel column c3870 to a 3,900th pixel column c3900 are dummy pixel columns. The pixels forming the effective display portion DSP_{eff} and the pixels forming the dummy pixel columns have substantially the same structure, and include switching elements.

A switching element in the Nth row of the first pixel column positioned at one end of the effective display portion and a switching element in the (N+1)th row of the dummy pixel column (i.e., the 0th pixel column) adjacent to the first pixel column are connected to a signal line in the first column.

In this pixel arrangement, a controller rearranges video data so that a predetermined video signal is output to the signal line in the first column at the timing at which a driving signal is output to a scanning line in the Nth row, and a dummy video signal is output to the same signal line at the timing at which a driving signal is output to a scanning line in the (N+1)th row.

That is, in the example shown in FIGS. 3 and 4, a switching element in the Nth row (e.g., an odd-numbered row) of the 31st pixel column c31 positioned at one end of the effective display portion DSP_{eff} and a switching element in the (N+1)th row (e.g., an even-numbered row) of the dummy pixel column c30 adjacent to the pixel column c31 are connected to the signal line X31 in the 31st column.

In this pixel arrangement, a controller CNT rearranges video data so that a predetermined video signal R1 is output to the signal line X31 at the timing at which a driving signal is output to a scanning line (e.g., Y1, Y3, Y5, . . . ) in the Nth row, and a dummy video signal D is output to the signal line X31 at the timing at which a driving signal is output to a scanning line (e.g., Y2, Y4, Y6, . . . ) in the (N+1)th row. The predetermined video signal R1 and dummy video signal D output to the same signal line X31 at different timings (in different horizontal scanning periods) in the same frame naturally have the same polarity.

Consequently, a switching element SW in the Nth row of the pixel column c31 is set at a pixel potential corresponding to the video signal R1. Also, a switching element SW in the (N+1)th row of the pixel column c30 is set at a pixel potential corresponding to the dummy video signal D.

A switching element in the Nth row of the dummy pixel column (i.e., the (m+1)th pixel column) adjacent to the mth pixel column positioned at the other end of the effective display portion and a switching element in the (N+1)th row of the mth pixel column are connected to a signal line in the (m+1)th column.

In this pixel arrangement, the controller rearranges video data so that a dummy video signal is output to the signal line in the (m+1)th column at the timing at which a driving signal is output to the scanning line in the Nth row, and a predetermined video signal is output to the signal line in the (m+1)th column at the timing at which a driving signal is output to the scanning line in the (N+1)th row.

That is, in the example shown in FIGS. 3 and 4, a switching element SW in the Nth row (e.g., an odd-numbered row) of the dummy pixel column c3871 adjacent to the 3,870th pixel column c3870 positioned at the other end of the effective display portion DSP_{eff} and a switching element SW in the (N+1)th row (e.g., an even-numbered row) of the pixel column c3870 are connected to the 3871st signal line X3871.

In this pixel arrangement, the controller CNT rearranges video data so that the dummy video signal D is output to the signal line X3871 at the timing at which a driving signal is output to the scanning line (e.g., Y1, Y3, Y5, . . . ) in the Nth row, and a predetermined video signal B1280 is output to the signal line X3871 at the timing at which a driving signal is output to the scanning line (e.g., Y2, Y4, Y6, . . . ) in the (N+1)th row. The predetermined video signal B1280 and dummy video signal D output to the same signal line X3871 at different timings (in different horizontal scanning periods) in the same frame naturally have the same polarity.

Consequently, a switching element SW in the Nth row of the dummy pixel column c3871 is set at a pixel potential corresponding to the dummy video signal D. Also, a switching element SW in the (N+1)th row of the pixel column c3870 is set at a pixel potential corresponding to the video signal B1280.

More specifically, the controller CNT rearranges video data into R1, G1, B1, R2, . . . , R1280, G1280, and B1280 at the timing at which the scanning line in the Nth row (e.g., an odd-numbered row) is driven, and outputs the rearranged video data to the signal line driving ICs 120. The signal line driving ICs 120 serially output the video signals R1, G1, B1, R2, R1280, G1280, and B1280 to the 3,841 signal lines X31, X32, X33, X34, . . . , X3868, X3869, X3870, and X3871, respectively.

Subsequently, the controller CNT rearranges the video data into D, R1, G1, B1, R2, . . . , R1280, G1280, and B1280 at the timing at which the scanning line in the (N+1)th row (e.g., an even-numbered row) is driven, and outputs the rearranged video data to the signal line driving ICs 120. The signal line driving ICs 120 serially output the video signals D, R1, G1, B1, R2, . . . , R1280, G1280, and B1280 to the signal lines X31, X32, X33, X34, . . . , X3868, X3869, X3870, and X3871, respectively.

As described above, video signals of 3,841 pixels are sequentially output to the 3,841 signal lines, but video signals which actually contribute to display are those of 3,840 pixels, and a signal of one pixel is a dummy video signal which does not contribute to actual display. Therefore, video signals are output to the 3,840 pixels forming the effective display portion DSP_{eff}, and a dummy video signal is output to the dummy pixel outside the effective display portion DSP_{eff}.

By repetitively performing the above signal processing after that, the unique relationship between the lines and pixel arrangement is compensated for by the video signal output order.

A polarity signal POLL is fixed while pixel potentials are written in all pixels of one frame as described above, and its polarity is inverted in each frame. All the sections XD1 to XD10 of the signal line driving ICs 120 output, to the individual signal lines, video signals having polarities controlled on the basis of the polarity signal POL1.

In the Fth frame (e.g., an odd-numbered frame), for example, the polarity signal POLL is fixed at High. On the basis of inputting of the polarity signal POLL fixed at High, the sections XD1 to XD10 output relatively positive video signals to signal lines in odd-numbered columns, and relatively negative video signals to signal lines in even-numbered columns.

Also, in the (F+1)th frame (e.g., an even-numbered frame) following the Fth frame, the polarity signal POL1 is fixed at Low. On the basis of inputting of the polarity signal POLL fixed at Low, the sections XD1 to XD10 output relatively negative video signals to the signal lines in the odd-numbered columns, and relatively positive video signals to the signal lines in the even-numbered columns.

In this manner, when the number of signal lines allocated to each section is an even number (e.g., 390), dot inversion driving and frame inversion driving are made possible by only one polarity signal POL1.

### Second Embodiment

In the second embodiment as shown in FIG. 5, signal line driving ICs 120 have 3,870 output channels for outputting video signals to 3,870 signal lines X1 to X3870, and include 10 sections XD1 to XD10 each allocated to 387 signal lines.

In the example shown in FIG. 5, 3,840 pixel columns from a first pixel column c1 to a 3,840th pixel column c3840 form an effective display portion DSP_{eff}. Also, a 0th pixel column c0 adjacent to the pixel column c1 is a dummy pixel column. In addition, 30 pixel columns from a 3841st pixel column c3841 adjacent to the pixel column c3840 to a 3870th pixel column c3870 are dummy pixel columns. The pixels in the effective display portion DSP_{eff} and the pixels in the dummy pixel columns have substantially the same structure, and include switching elements.

A switching element in the Nth row of the first pixel column positioned at one end of the effective display portion and a switching element in the (N+1)th row of the dummy pixel column (i.e., the 0th pixel column) adjacent to the first pixel column are connected to a signal line in the first column.

In this pixel arrangement, a controller rearranges video data so that a predetermined video signal is output to a signal line in the first column at the timing at which a driving signal is output to a scanning line in the Nth row, and a dummy video signal is output to the same signal line at the timing at which a driving signal is output to a scanning line in the (N+1)th row.

That is, in the example shown in FIGS. 5 and 6, a switching element in the Nth row (e.g., an odd-numbered row) of the first pixel column c1 positioned at one end of the effective display portion DSP_{eff} and a switching element in the (N+1)th row (e.g., an even-numbered row) of the dummy pixel column c0 adjacent to the pixel column c1 are connected to the signal line X1 in the first column.

In this pixel arrangement, a controller CNT rearranges video data so that a predetermined video signal R1 is output to the signal line X1 at the timing at which a driving signal is output to a scanning line (e.g., Y1, Y3, Y5, . . . ) in the Nth row, and a dummy video signal D is output to the signal line X1 at the timing at which a driving signal is output to a scanning line (e.g., Y2, Y4, Y6, . . . ) in the (N+1)th row. The predetermined video signal R1 and dummy video signal D output to the same signal line X1 at different timings (in different horizontal scanning periods) in the same frame naturally have the same polarity.

Consequently, a switching element SW in the Nth row of the pixel column c1 is set at a pixel potential corresponding to the video signal R1. Also, a switching element SW in the (N+1)th row of the pixel column c0 is set at a pixel potential corresponding to the dummy video signal D.

A switching element in the Nth row of the dummy pixel column (i.e., the (m+1)th pixel column) adjacent to the mth pixel column positioned at the other end of the effective display portion and a switching element in the (N+1)th row of the mth pixel column are connected to a signal line in the (m+1)th column.

In this pixel arrangement, the controller rearranges video data so that a dummy video signal is output to the signal line in the (m+1)th column at the timing at which a driving signal is output to the scanning line in the Nth row, and a predetermined video signal is output to the signal line in the (m+1)th column at the timing at which a driving signal is output to the scanning line in the (N+1)th row.

That is, in the example shown in FIGS. 5 and 6, a switching element SW in the Nth row (e.g., an odd-numbered row) of the dummy pixel column c3841 adjacent to the 3,840th pixel column c3840 positioned at the other end of the effective display portion DSP_{eff} and a switching element SW in the (N+1)th row (e.g., an even-numbered row) of the pixel column c3840 are connected to the 3,841st signal line X3841.

In this pixel arrangement, the controller CNT rearranges video data so that the dummy video signal D is output to the signal line X3841 at the timing at which a driving signal is output to the scanning line (e.g., Y1, Y3, Y5, . . . ) in the Nth row, and a predetermined video signal B1280 is output to the signal line X3841 at the timing at which a driving signal is output to the scanning line (e.g., Y2, Y4, Y6, . . . ) in the (N+1)th row. The predetermined video signal B1280 and dummy video signal D output to the same signal line X3841 at different timings (in different horizontal scanning periods) in the same frame naturally have the same polarity.

Consequently, a switching element SW in the Nth row of the dummy pixel column c3841 is set at a pixel potential corresponding to the dummy video signal D. Also, a switching element SW in the (N+1)th row of the pixel column c3840 is set at a pixel potential corresponding to the video signal B1280.

More specifically, the controller CNT rearranges video data into R1, G1, B1, R2, . . . , R1280, G1280, and B1280 at the timing at which the scanning line in the Nth row (e.g., an odd-numbered row) is driven, and outputs the rearranged video data to the signal line driving ICs 120. The signal line driving ICs 120 serially output the video signals R1, G1, B1, R2, . . . , R1280, G1280, and B1280 to the 3,841 signal lines X1, X2, X3, X4, . . . , X3838, X3839, X3840, and X3841, respectively.

Subsequently, the controller CNT rearranges the video data into D, R1, G1, B1, R2, . . . , R1280, G1280, and B1280 at the timing at which the scanning line in the (N+1)th row (e.g., an even-numbered row) is driven, and outputs the rearranged video data to the signal line driving ICs 120. The signal line driving ICs 120 serially output the video signals D, R1, G1, B1, R2, . . . , R1280, G1280, and B1280 to the signal lines X1, X2, X3, X4, . . . , X3838, X3839, X3840, and X3841, respectively.

As described above, video signals of 3,841 pixels are sequentially output to the 3,841 signal lines, but video signals which actually contribute to display are those of 3,840 pixels, and a signal of one pixel is a dummy video signal which does not contribute to actual display. Therefore, video signals are output to the 3,840 pixels forming the effective display portion DSP_{eff}, and a dummy video signal is output to the dummy pixel outside the effective display portion DSP_{eff}.

By repetitively performing the above signal processing after that, the unique relationship between the lines and pixel arrangement is compensated for by the video signal output order.

First and second polarity signals POLL and POL2 are fixed to opposite polarities while pixel potentials are written in all pixels of one frame as described above, and their polarities are inverted in each frame. The odd-numbered sections XD1, XD3, XD5, XD7, and XD9 of the signal line driving ICs 120 output, to the individual signal lines, video signals having polarities controlled on the basis of the first polarity signal POLL. The even-numbered sections XD2, XD4, XD6, XD8, and XD10 of the signal line driving Ics 120 output, to the individual signal lines, video signals having polarities controlled on the basis of the second polarity signal POL2.

In the Fth frame (e.g., an odd-numbered frame), for example, the first polarity signal POLL is fixed at High, and the second polarity signal POL2 is fixed at Low.

On the basis of inputting of the first polarity signal POL1 fixed at High, the sections XD1, XD3, XD5, XD7, and XD9 output relatively positive video signals to signal lines in odd-numbered columns of these sections, and relatively negative video signals to signal lines in even-numbered columns. In the example shown in FIG. 5, the section XD1 outputs positive-polarity video signals to the signal lines X1, X3, X5, . . . , X387 in odd-numbered columns, and negative-polarity video signals to the signal lines X2, X4, X6, . . . , X386 in even-numbered columns.

Also, on the basis of inputting of the second polarity signal POL2 fixed at Low, the sections XD2, XD4, XD6, XD8, and XD10 output relatively negative video signals to signal lines in odd-numbered columns (signal lines in even-numbered columns as a whole) of these sections, and relatively positive video signals to signal lines in even-numbered columns. In the example shown in FIG. 5, the section XD2 outputs negative-polarity video signals to the signal lines X388, X390, X392, . . . , X774 in odd-numbered columns, and positive-polarity video signals to the signal lines X389, X391, X393, . . . , X773 in even-numbered columns.

In the (F+1)th frame (e.g., an even-numbered frame), for example, the first polarity signal POL1 is fixed at Low, and the second polarity signal POL2 is fixed at High.

On the basis of inputting of the first polarity signal POL1 fixed at Low, the sections XD1, XD3, XD5, XD7, and XD9 output relatively negative video signals to the signal lines in the odd-numbered columns of these sections, and relatively positive video signals to the signal lines in the even-numbered columns. In the example shown in FIG. 5, the section XD1 outputs negative-polarity video signals to the signal lines X1, X3, X5, . . . , X387 in the odd-numbered columns, and positive-polarity video signals to the signal lines X2, X4, X6, . . . , X386 in the even-numbered columns.

Also, on the basis of inputting of the second polarity signal POL2 fixed at High, the sections XD2, XD4, XD6, XD8, and XD10 output relatively positive video signals to the signal lines in the odd-numbered columns (the signal lines in the even-numbered columns as a whole) of these sections, and relatively negative video signals to the signal lines in the even-numbered columns. In the example shown in FIG. 5, the section XD2 outputs positive-polarity video signals to the signal lines X388, X390, X392, . . . , X774 in the odd-numbered columns, and negative-polarity video signals to the signal lines X389, X391, X393, . . . , X773 in the even-numbered columns.

In this manner, when the number of signal lines allocated to each section is an odd number (e.g., 387), dot inversion driving and frame inversion driving are made possible by the control using the two polarity signals POL1 and POL2.

As described above, the display device array substrate according to this embodiment includes dummy pixel columns obtained by arranging dummy pixels outside a rectangular effective display portion having n rows×m columns, one switching element is connected per row to each signal line, a switching element in the Nth row of the Mth pixel column and a switching element in the (N+1)th row of the (M+1)th pixel column are connected to the same signal line, and video signals having opposite polarities are supplied to adjacent signal lines, thereby making dot inversion driving possible. Also, during this dot inversion driving, video signals having the same polarity are supplied to the same signal line over one frame, i.e., n horizontal scanning periods (one vertical scan period). In addition, video signals having opposite polarities are alternately supplied to each signal line in every other frame, thereby making frame inversion driving possible. This reduces the load on the signal line driving IC.

Also, each pixel can be reliably charged. In addition, since the polarities of the applied voltages to adjacent pixel columns are changed, no flicker occurs, and deterioration of the display quality can be prevented even when the screen size is increased. Furthermore, the arrangement of the signal line driving ICs can be simplified.

The liquid crystal display panel LPN according to the above embodiment was able to display images having high display quality although, for example, the wiring capacitance was 180 pF and the wiring resistance was 3 kΩ in the effective display portion DSP_{eff} having a diagonal length of 32 inches. Also, this embodiment was able to display images having high display quality even when the wiring resistance increased to 300 pF by changes in layout of the array substrate.

The controller which outputs video data to the signal line driving ICs rearranges the video data in accordance with the special pixel arrangement described above. Therefore, normal images can be displayed on the effective display portion formed by the special pixel arrangement.

Although display device array substrates applied to liquid crystal display devices are explained in the above embodiments, the present invention is, of course, also applicable to other display devices, e.g., flat display devices such as an organic electroluminescence (EL) display device.

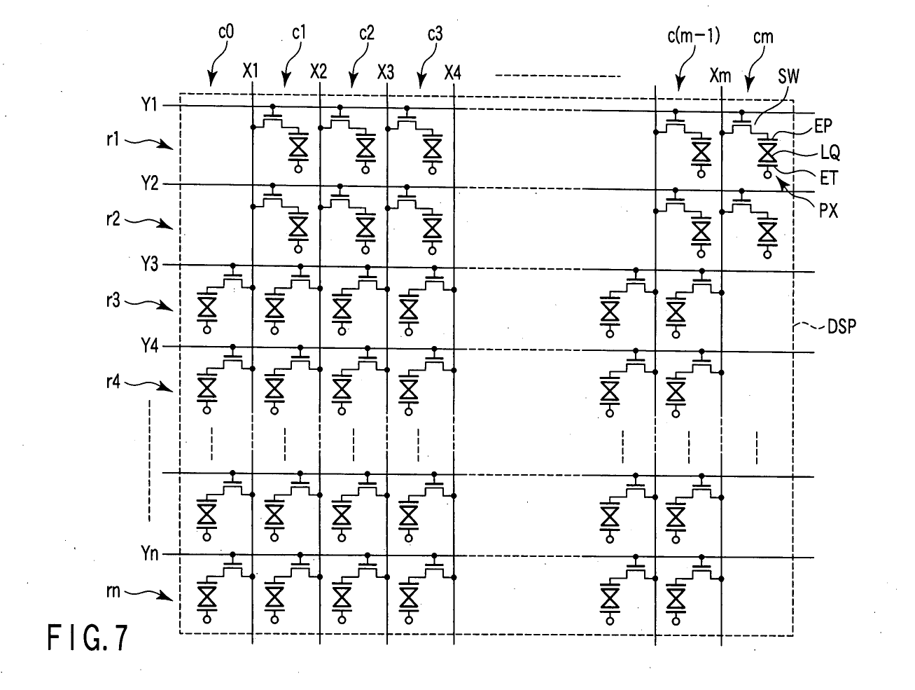

Also, in the example shown in FIG. 2 the switching elements SW connected to one signal line are alternately arranged in two pixel columns in every other row, but the present invention is not limited to these examples. That is, the switching elements SW connected to one signal line may also be alternately arranged in two pixel columns in every two or more rows. For example, in the arrangement of the first embodiment, as shown in FIG. 7, the switching elements SW in the Nth row rN and (N+1)th row r(N+1) of the Mth pixel column cM and the switching elements SW in the (N+2)th row r(N+2) and (N+3)th row r(N+3) of the (M+1)th pixel column c(M+1) are connected to the same signal line X. That is, the switching elements SW connected to one signal line are alternately arranged in two pixel columns in every two rows. Even when the display portion is formed by this pixel arrangement, the same effect is obtained by rearranging video data in the same manner as above.

Note that in order to prevent deterioration of the display quality such as flicker, the repeating period in which switching elements connected to the same signal line are alternately arranged in two pixel columns is desirably four rows or less.

The polarity inversion timing of video signals output from the signal line driving ICs is not limited to one frame. For example, the polarity inversion timing may also be two or more frames, but is desirably ten frames or less in order to prevent the wear on the screen.

Furthermore, the relationship between the Mth and (M+1)th columns corresponds to any adjacent pixel columns, so these columns are not particularly limited to an even-numbered column and odd-numbered column. Similarly, the relationship between the Nth and (N+1)th rows corresponds to any adjacent rows, so these rows are not particularly limited to an even-numbered row and odd-numbered row.

The present invention naturally includes a case in which a switching element in the Nth row of the (M+1)th pixel column and a switching element in the (N+1)the row of the M pixel column are connected to the same signal line, and a case in which a switching element in the Nth row of the Mth pixel column and a switching element in the (N+1)th row of the (M+1)th pixel column is connected to the same signal line.

Note that the present invention is not directly limited to the embodiments described above, but can be embodied by modifying the constituent elements, when the invention is practiced, without departing from the spirit and scope of the invention. Note also that various inventions can be formed by appropriately combining a plurality of constituent elements disclosed in the embodiments. For example, it is also possible to delete some of all the constituent elements disclosed in the embodiments. Furthermore, constituent elements disclosed over different embodiments may also be appropriately combined.

As has been explained above, the present invention can provide a display device array substrate and display device capable of preventing deterioration of the display quality, and reducing the load on a driving circuit without increasing the cost.

1. A display device array substrate comprising:
a plurality of scanning lines running in a row direction on a substrate;
a plurality of signal lines running in a column direction on the substrate; and
an effective display portion having m pixel columns in each of which n rows of pixels are arranged,
wherein the display device array substrate comprises dummy pixel columns obtained by arranging dummy pixels on outsides of the effective display portion, which are adjacent to first and mth pixel columns of the effective display portion,
each pixel and each dummy pixel include a switching element placed at an intersection of each scanning line and each signal line, and
one switching element is connected per row to each signal line, a switching element in an Nth row of an Mth pixel column and a switching element in an (N+1)th row of an (M+1)th pixel column are connected to the same signal line, and video signals having opposite polarities are supplied to adjacent signal lines.

2. A display device array substrate according to claim 1, wherein one pixel column placed between first and second signal lines adjacent to each other comprises a switching element connected to the first signal line in the Nth row, and a switching element connected to the second signal line in the (N+1)th row.

3. A display device array substrate according to claim 1, wherein one pixel column is placed between two adjacent signal lines, switching elements in odd-numbered rows forming each pixel column are connected to a signal line placed along one side of the pixel column, and switching elements in even-numbered rows forming the pixel column are connected to a signal line placed along the other side of the pixel column.

4. A display device array substrate according to claim 1, further comprising:
a scanning line driving circuit which is connected to each scanning line, and outputs a driving signal for driving switching elements connected to the same scanning line;
a controller which rearranges video data in a predetermined order in accordance with an arrangement of the pixels; and
a signal line driving circuit which is connected to each signal line, and outputs a video signal to each signal line on the basis of the video data rearranged by the controller.

5. A display device array substrate according to claim 4, wherein the signal line driving circuit alternately outputs video signals having different polarities to the same signal line in every other frame.

6. A display device array substrate according to claim 4, wherein a switching element in the Nth row of the first pixel column positioned at one end of the effective display portion and a switching element in the (N+1)th row of the dummy pixel column adjacent to the first pixel column are connected to a signal line in the first column, and
the controller rearranges video data such that a predetermined video signal is output to the signal line in the first column at a timing at which a driving signal is output to a scanning line in the Nth row, and a dummy video signal is output to the same signal line at a timing at which a driving signal is output to a scanning line in the (N+1)th row.

7. A display device array substrate according to claim 6, wherein the dummy video signal and predetermined video signal have the same polarity.

8. A display device array substrate according to claim 4, wherein a switching element in the Nth row of the dummy pixel column adjacent to the mth pixel column positioned at the other end of the effective display portion and a switching element in the (N+1)th row of the mth pixel column are connected to a signal line in the (m+1)th column, and
the controller rearranges video data such that a dummy video signal is output to the signal line in the (m+1)th column at a timing at which a driving signal is output to a scanning line in the Nth row, and a predetermined video signal is output to the same signal line at a timing at which a driving signal is output to a scanning line in the (N+1)th row.

9. A display device array substrate according to claim 8, wherein the dummy video signal and the predetermined video signal have the same polarity.

10. A display device array substrate according to claim 4, wherein
the signal line driving circuit comprises at least two sections each allocated to a predetermined number of signal lines,
each section has an even number of channels which output video signals to an even number of signal lines, and
two adjacent sections output, to individual signal lines, video signals whose polarities are controlled on the basis of a polarity signal which inverts polarity in each frame.

11. A display device array substrate according to claim 4, wherein
the signal line driving circuit comprises at least two sections each allocated to a predetermined number of signal lines,
each section has an odd number of channels which output video signals to an odd number of signal lines,
a first section outputs, to each signal line, a video signal whose polarity is controlled on the basis of a first polarity signal which inverts polarity in each frame,
and a second section adjacent to the first section outputs, to each signal line, a video signal whose polarity is controlled on the basis of a second polarity signal which has a polarity opposite to that of the first polarity signal.

12. A display device comprising:
an array substrate including a plurality of scanning lines running in a row direction on a substrate, a plurality of signal lines running in a column direction on the substrate, and a switching element placed at an intersection of each scanning line and each signal line;
a counter-substrate which opposes the array substrate; and
a liquid crystal layer held between the array substrate and counter-substrate,
wherein the display device comprises an effective display portion having m pixel columns in each of which n pixels are arranged, and dummy pixel columns obtained by arranging dummy pixels on outsides of the effective display portion, which are adjacent to first and mth pixel columns of the effective display portion, each pixel and each dummy pixel including the switching element,
the display device further comprises:
a scanning line driving circuit which is connected to each scanning line, and outputs a driving signal for driving switching elements connected to the same scanning line;
a controller which rearranges video data in a predetermined order in accordance with an arrangement of the pixels; and
a signal line driving circuit which is connected to each signal line, and outputs a video signal to each signal line on the basis of the video data rearranged by the controller, and
one switching element is connected per row to each signal line, a switching element in an Nth row of an Mth pixel column and a switching element in an (N+1)th row of an (M+1)th pixel column are connected to the same signal line, and video signals having opposite polarities are supplied to adjacent signal lines.
